(19) United States
(12) Patent Application Publication
(10) Pub. No.: US 2012/0229559 A1
(43) Pub. Date: Sep. 13, 2012

(54) INK SET

(75) Inventor: Yasuaki MATSUSHITA, Ashigarakami-gun (JP)

(73) Assignee: FUJIFILM CORPORATION, Tokyo (JP)

(21) Appl. No.: 13/416,787

(22) Filed: Mar. 9, 2012

(30) Foreign Application Priority Data
Mar. 11, 2011 (JP) 2011-054518

(51) Int. Cl. B41J 2/015; B05D 5/00; C09D 11/02

(52) U.S. Cl. 347/21; 106/31.6; 106/31.86; 427/258

(57) ABSTRACT

The present invention provides an ink set which has a good discharge stability, with which high-definition images are obtained even when printing at high speed, and which is excellent in drying characteristics and thereby it is difficult for offset to occur.

An ink set containing an ink composition containing (a) a pigment, (b) a water-soluble solvent, (c) a surfactant, and (d) water, and a colorless ink composition containing (e) a coagulation accelerator for accelerating the coagulation of the ink composition, and (f) a water-soluble solvent, characterized in that the water-soluble solvent (b) of the ink composition contains 65% by mass or more of a water-soluble solvent having an SP value of 27.5 or less, and the content of the water-soluble solvent (b) in the ink composition is from 30% by mass to 55% by mass, and that the water-soluble solvent (f) of the colorless ink composition contains 90% by mass or more of a water-soluble solvent having an SP value of 27.5 or more.

### BACKGROUND OF THE INVENTION

1. Field of the Invention

The present invention relates to an ink set and an image forming method using the ink set.

2. Description of the Related Art

An inkjet recording method has many advantages, such as in that the method allows high-speed recording with less noise, makes the colorization easy, allows high resolution, and allows recording on a plain paper. Owing to these advantages, equipment and facilities that have utilized the recording method are remarkably widespread in use. In recent years, with advancement of inkjet recording technology, the inkjet recording method has also come to be used for the formation of high-resolution images which so far have been mainly formed by photography and off-set printing. In the inkjet recording method, whereby high-quality is demanded, a special paper for an inkjet wherein an image-receiving layer, and the like is provided on a support such as paper, is generally used. As an ink which is used for such the inkjet recording method having high quality, a variety of inks have been reported (see, for example, JP2009-190379A).

On the other hand, the inkjet recording method has also come to be adopted for the use for printing a wide variety of prints in small quantities at high speed, at a low cost. In such a use, in terms of cost, as a recording medium, it is desirable not to use a coated paper such as a photo paper provided on an image-receiving layer, an art paper, or a coat paper, but to use a non-coated paper wherein coating processing or a functional layer is not provided on the surface of high-quality paper, plain paper, or recycled paper, and the like. Therefore, a technology for forming vivid images at high speed using a non-coated paper as a recording medium is required.

As an inkjet ink suitable for printing onto plain paper, an inkjet ink has been reported, wherein the ink contains 30% by mass or more of a water-soluble solvent having an SP value of 16.5 or more but less than 24.6, and 10% by mass or more but less than 50% by mass of water, relative to the entire ink, and a pigment is dispersed therein by an alkali-soluble polymer dispersant (see JP2007-145887A).

### SUMMARY OF THE INVENTION

The object of the present invention is to provide an ink set which has a good discharge stability, with which high-definition images are obtained even when printing at high speed, and which is excellent in drying characteristics and thereby it is difficult for offset to occur. In addition, the object of the present invention is to provide an image forming method using the ink set.

As a result of intensive studies in view of the above-mentioned problems, the present inventors found that in an ink set using an ink composition containing a coloring material and a colorless ink composition, by using a water-soluble solvent having low polarity for the ink composition and a high polar solvent for the colorless ink composition, respectively, high-definition images can be obtained. The present invention has been completed based on such findings.

That is to say, the ink set of the present invention to solve the problems described above is an ink set containing: an ink composition containing (a) a pigment, (b) a water-soluble solvent, (c) a surfactant, and (d) water, and a colorless ink composition containing (e) a coagulation accelerator for accelerating the coagulation of the ink composition, and (f) a water-soluble solvent, in which the water-soluble solvent (b) of the ink composition contains 65% by mass or more of a water-soluble solvent having an SP value of 27.5 or less, and the content of the water-soluble solvent (b) in the ink composition is from 30% by mass to 55% by mass, and the water-soluble solvent (f) of the colorless ink composition contains 90% by mass or more of a water-soluble solvent having an SP value of 27.5 or more. In the following description, “(from) xx to yy” means that it includes numerical values designated by “xx” and “yy” as a lower limit and an upper limit, respectively.

In the present invention, it is a preferable embodiment that the water-soluble solvent having an SP value of 27.5 or less in the water-soluble solvent (b) includes a compound represented by the following general formula (1) or (2).

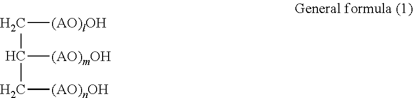

wherein, l, m, and n each independently represent an integer of 1 or more, and l+m+n=3 to 15; AO represents an ethyleneoxy group, or a propyleneoxy group, and plural AOs may be the same as each other or may be different from each other.

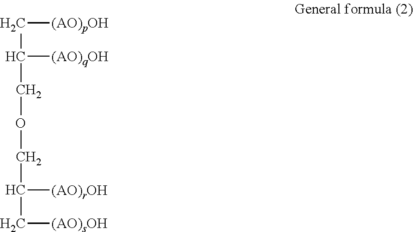

wherein, p, q, r and s each independently represent an integer of 1 or more, and p+q+r+s=4 to 40; AO represents an ethyleneoxy group, or a propyleneoxy group, and plural AOs may be the same as each other or may be different from each other.

In addition, in the present invention, it is also a preferable embodiment that AO in the general formula (1) or (2) is a propyleneoxy group; that the water-soluble solvent having an SP value of 27.5 or more in the water-soluble solvent (f) of the colorless ink composition includes at least one selected from a group consisting of glycerin, propylene glycol, diglycerin, glycerin monoacetate, diethylene glycol, and triethylene glycol, and 1,2-alkylene diol; that the pigment (a) is a pigment coated with a polymer, which has been obtained through a step of dispersing the pigment using a water-soluble dispersant, followed by crosslinking with a crosslinking agent; and that the coagulation accelerator (e) in the colorless ink composition is an acid. The present invention also includes an image forming method using the ink set described above.

It is a preferable embodiment that the image forming method of the present invention includes a first step of applying the colorless ink composition onto a recording medium; and a second step of applying the ink composition onto the recording medium onto which the colorless ink composition has been applied. In addition, in the present invention, it is also a preferable embodiment that the recording medium is a non-coated paper; that the application of the ink composition onto the recording medium is performed by an inkjet ejecting method; that the application of the colorless ink composition onto the recording medium is performed by an inkjet ejecting method; and that the application of the colorless ink composition onto the recording medium is performed by a method of coating using coating applicator.

The ink set of the present invention has a good discharge stability, with which high-definition images quality images are obtained even when printing at high speed on a plain paper, and is excellent in drying characteristics and thereby it is difficult for offset to occur. In addition, the image forming method using the ink set of the present invention enables printing on plain paper at high speed, and formation of high-definition images which allow easy discrimination between characters, and the like.

### DESCRIPTION OF THE PREFERRED EMBODIMENTS

[Ink Set]

The ink set of the present invention contains the ink composition of the following 1), and the colorless ink composition of the following 2):

1) An ink composition containing (a) a pigment, (b) a water-soluble solvent, (c) a surfactant, and (d) water, wherein the water-soluble solvent (b) of the ink composition contains 65% by mass or more of a water-soluble solvent having an SP value of 27.5 or less, and the content of the water-soluble solvent (b) in the ink composition is from 30% by mass to 55% by mass.
2) An colorless ink composition containing (e) a coagulation accelerator for accelerating the coagulation of the ink composition, and (f) a water-soluble solvent, wherein the water-soluble solvent (f) of the colorless ink composition contains 90% by mass or more of a water-soluble solvent having an SP value of 27.5 or more.

The ink composition and the ink set of the present invention are suitably used for an inkjet recording method.

[Ink Composition]

(a) Pigment

The ink compositions of the present invention include a pigment as a coloring material. The pigment used is not particularly limited, and can be appropriately selected from the pigments usually used for inks, and the like, depending on the purpose. In addition, any organic pigments or inorganic pigments may be used.

Examples of the organic pigment include azo pigments, polycyclic pigments, dye chelates, nitro pigments, nitroso pigments, and aniline black. Among these pigments, azo pigments, and polycyclic pigments are more preferable. Examples of the azo pigments include an azo lake pigment, an insoluble azo pigment, a condensed azo pigment, and a chelate azo pigment. Examples of the polycyclic pigments include a phthalocyanine pigment, a perylene pigment, a perynone pigment, an anthraquinone pigment, a quinacridone pigment, a dioxazine pigment, an indigo pigment, a thioindigo pigment, an isoindolinone pigment, and a quinofuraron pigment.

Examples of the inorganic pigments include titanium oxide, iron oxide, calcium carbonate, barium sulfate, aluminum hydroxide, barium yellow, cadmium red, chrome yellow, and carbon black. Among these pigments, carbon black is particularly preferable. In addition, for example, a carbon black manufactured by a known method such as a contact method, a furnace method, or a thermal method, can be used.

The pigments which can be used in the present invention are illustrated below by colors.

Specific examples of a carbon black, which is an example of black pigments, include, but are not limited to: Raven 7000, Raven 5750, Raven 5250, Raven 5000 ULTRA II, Raven 3500, Raven 2000, Raven 1500, Raven 1250, Raven 1200, Raven 1190 ULTRA II, Raven 1170, Raven 1255, Raven 1080, Raven 1060, and Raven 700 (all manufactured by Columbian Carbon Company); Regal 400R, Regal 330R, Regal 660R, Mogul L, Black Peals L, Monarch 700, Monarch 800, Monarch 880, Monarch 900, Monarch 1000, Monarch 1100, Monarch 1300, and Monarch 1400 (all, manufactured by Cabot Corporation); Color Black FW1, Color Black FW2, Color Black FW2V, Color Black 18, Color Black FW200, Color Black S150, Color Black S160, Color Black S170, Printex 35, Printex U, Printex V, Printex 140U, Printex 140V, Special Black 6, Special Black 5, Special Black 4A, and Special Black 4 (all manufactured by Degussa); and No. 25, No. 33, No. 40, No. 45, No. 47, No. 52, No. 900, No. 2200B, No. 2300, MCF-88, MA600, MA7, MA8, and MA100 (all manufactured by Mitsubishi Chemical Corporation).

Examples of yellow ink pigments include C.I. Pigment Yellow 1, 2, 3, 4, 5, 6, 7, 10, 11, 12, 13, 14, 14C, 16, 17, 24, 34, 35, 37, 42, 53, 55, 65, 73, 74, 75, 81, 83, 93, 95, 97, 98, 100, 101, 104, 108, 109, 110, 114, 117, 120, 128, 129, 138, 150, 151, 153, 154, 155, and 180.

Examples of magenta ink pigments include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48 (Ca), 48 (Mn), 48:2, 48:3, 48:4, 49, 49:1, 50, 51, 52, 52:2, 53:1, 53, 55, 57 (Ca), 57:1, 60, 60:1, 63:1, 63:2, 64, 64:1, 81, 83, 87, 88, 89, 90, 101 (rouge), 104, 105, 106, 108 (cadmium red), 112, 114, 122 (quinacridone magenta), 123, 146, 149, 163, 166, 168, 170, 172, 177, 178, 179, 184, 185, 190, 193, 202, 209, 219, and 269; and C.I. Pigment Violet 19, and C.I. Pigment Red 122 is particularly preferable.

Examples of cyan ink pigments include C.I. Pigment Blue 1, 2, 3, 15, 15:1, 15:2, 15:3, 15:34, 16, 17:1, 22, 25, 56, and 60; C.I. Vat Blue 4, 60, and 63, and C.I. Pigment Blue 15:3 is particularly preferable.

The aforementioned pigments may be used singly, or in combination of two or more thereof, each of which may be selected from the aforementioned respective groups or from two or more respective groups.

While the content of the pigment in the ink composition of the present invention is not particularly limited, it is preferably from 0.5% by mass to 10% by mass, more preferably 1% by mass to 8% by mass, and particularly preferably 2% by mass to 7% by mass, relative to the total mass of the ink composition.

It is preferable that the pigment used in ink compositions of the present invention be a pigment coated with a polymer, which has been obtained through a step of dispersing the pigment using a water-soluble dispersant, followed by crosslinking by a crosslinking agent (hereinafter, also referred to as “a water-dispersible pigment”).

Examples of the water-soluble dispersant used for preparing the pigment include polyvinyls, polyurethanes, and polyesters, and among them, polyvinyls are preferable.

The water-soluble dispersant preferably has a group, in the molecule, which is crosslinked by a crosslinking agent. The group which is crosslinked, is not particularly limited, and examples thereof include a carboxyl group or a salt thereof, an isocyanate group, and an epoxy group. Among them, from the viewpoint of improving dispersibility, the dispersant having a carboxyl group or a salt thereof is preferable. Such a water-soluble dispersant can be synthesized using a carboxyl group-containing monomer as a copolymerizable component. Examples of the carboxyl group-containing monomer include methacrylic acid, b-carboxyethyl acrylate, fumaric acid, itaconic acid, maleic acid, and crotonic acid. Among them, from the viewpoint of crosslinkability and dispersion stability, methacrylic acid, and b-carboxyethyl acrylate are preferable.

In addition to the above, a hydrophilic monomer or a hydrophobic monomer can also be used as a copolymerization component. The hydrophilic monomer may also be ionic or nonionic. The hydrophobic monomer is not limited to, but is preferably an alkyl methacrylate having 1 to 20 carbon atoms, or an alkyl acrylate having 1 to 20 carbon atoms.

The polymer used as a water-soluble dispersant may be a random polymer, or may be a block or graft polymer. The synthesis method of the polymer is not particularly limited, but a random polymerization of a vinyl monomer, and the like, is preferable in terms of dispersion stability.

The acid value of the water-soluble dispersant (mg of KOH required for neutralizing 1 g of the water-soluble dispersant) is preferably from 135 to 250 mg KOH/g, more preferably from 135 to 200 mg KOH/g, and particularly preferably from 135 to 180 mg KOH/g, from the viewpoint of pigment dispersibility and dispersion stability.

The amount used of the water-soluble dispersant is preferably 10 parts by mass to 200 parts by mass, more preferably 20 parts by mass to 150 parts by mass, and particularly preferably from 30 parts by mass to 100 parts by mass, relative to 100 parts by mass of pigment.

A crosslinking agent is not particularly limited as long as it is a compound having two or more sites which react with the above-mentioned water-soluble dispersant. Among them, from the viewpoint of an excellent reactivity with a carboxyl group, a compound having two or more epoxy groups (a bifunctional or more epoxy compound) is preferable.

Specific examples thereof include ethylene glycol diglycidyl ether, polyethylene glycol diglycidyl ether, 1,6-hexane diol glycidyl ether, diethylene glycol diglycidyl ether, dipropylene glycol diglycidyl ether, and polypropylene glycol diglycidyl ether, and polyethylene glycol diglycidyl ether, and diethylene glycol diglycidyl ether are preferable.

The molar ratio of a crosslinking site of the crosslinking agent to the site to be crosslinked of the dispersant is preferably from 1:1.1 to 1:10, more preferably from 1:1.1 to 1:5, and particularly preferably from 1:1.1 to 1:3, from the viewpoint of the rate of the crosslinking reaction, and the stability of the dispersion liquid after crosslinking.

A process for the preparation of the water-dispersible pigment is not particularly limited as long as a pigment coated with a polymer is obtained through a step of dispersing the aforementioned pigment using the water-soluble dispersant, and thereafter, crosslinking by a crosslinking agent. Hereinafter, an example of a process for the preparation of the water-dispersible pigment is illustrated, but the present invention is not limited thereto.

(i) Pigment Dispersion Step

A pigment dispersion liquid is obtained by dispersing a pigment and a water-soluble dispersant in water or an aqueous solution of a polar solvent.

(ii) Crosslinking Reaction Step

A pigment coated with a polymer (a water-dispersible pigment) is obtained, by adding a crosslinking agent to the dispersion liquid obtained in (i), and heating the mixture to be subjected to the crosslinking reaction.

(iii) Pigment Purification Step

The water-dispersible pigment after the crosslinking, obtained in (ii), is purified.

Other common steps may be appropriately added to the above steps of (i) to (iii), as necessary. Common solvents can be used for the polar solvent, and the like used in the above steps.

(b) Water-Soluble Solvent

The ink compositions of the present invention contains a water-soluble solvent. The water-soluble solvent used in the present invention is preferably a water-soluble organic solvent. The ink composition of the present invention is suitably used, especially for inkjet recording method, but in the inkjet recording method, the ink composition is dried in the ink jet of nozzle, which becomes a cause of clogging. Therefore, it is preferable that a water-soluble organic solvent having a lower vapor pressure than water be used to increase the wettability of the ink composition and to prevent the ink composition from drying.

The water-soluble solvent (b) used in the ink composition contains 65% by mass or more of a water-soluble solvent having an SP value of 27.5 or less. The SP value in the present invention means the Solubility Parameter of the solvent, and is a value represented by a square root of molecular cohesion energy. The SP value can be calculated according to the method described in R. F. Fedors, Polymer Engineering & Science, 14, p. 147 (1967). The SP value of the water-soluble solvent used in the present invention adopts a value which is calculated by this method.

The water-soluble solvent having an SP value of 27.5 or less used in the ink composition is not particularly limited, but preferably has an SP value of from 20 to 27, and more preferably a value of from 23 to 26.7, from the viewpoint of the preservation stability of ink, discharge stability, and establishment of image quality.

Specific examples of the water-soluble solvent having an SP value of 27.5 or less are shown below, along with the SP value; however, the present invention is not limited to these. In addition, in the present specification, EO, and PO each represent an ethyleneoxy group, and a propyleneoxy group.

Heptaoxypropylene glycol (SP value of 21.2, for example, PP-400 (trade name, manufactured by Sanyo Chemical Industries, Ltd.)),

Pentaoxyethylene pentaoxypropylene butyl ether (SP value of 18.8, for example, 50HB-100 (trade name, manufactured by Sanyo Chemical Industries, Ltd.)),
Decaoxyethylene heptaoxypropylene butyl ether (SP value of 18.8, for example, 50HB-260 (trade name, manufactured by Sanyo Chemical Industries, Ltd.)),
Dodecaoxyethylene dodecaoxypropylene butyl ether (SP value of 18.8, for example, 50HB-400 (trade name, manufactured by Sanyo Chemical Industries, Ltd.)),
Decaoxyethylene triacontaoxypropylene butyl ether (SP value of 18.7, for example, PE-62 (trade name, manufactured by Sanyo Chemical Industries, Ltd.)),
Pentacosaoxyethylene triacontaoxypropylene butyl ether (SP value of 18.8, for example, PE-64 (trade name, manufactured by Sanyo Chemical Industries, Ltd.)).
Diethylene glycol monoethyl ether (DEGmEE) (SP value of 22.4)
Diethylene glycol monobutyl ether (DEGmBE) (SP value of 21.5)
Diethylene glycol diethyl ether (DEGdEE) (SP value of 16.8)
Triethylene glycol monobutyl ether (TEGmBE) (SP value of 21.1)
Propylene glycol monoethyl ether (PGmEE) (SP value of 22.3)
Dipropylene glycol (DPG) (SP value of 27.1)
Dipropylene glycol monomethyl ether (DPGmME) (SP value of 21.3)
Tripropylene glycol (TPG) (SP value of 24.7, for example PP-200 (trade name, manufactured by Sanyo Chemical Industries, Ltd.))
1,2-Hexanediol (SP value of 27.4)
2-Pyrrolidone (SP value of 25.9)
Hexylene glycol (2-methyl-2,4-pentane diol) (SP value of 26.8)
Trioxypropylene glyceryl ether (SP value of 26.4, for example, GP-250 (trade name, manufactured by Sanyo Chemical Industries, Ltd.))
Dioxyethylene dioxypropylene butyl ether (SP value of 20.1, for example, 50HB-55 (trade name, manufactured by Sanyo Chemical Industries, Ltd.))

POP (4) Diglyceryl ether (SP value of 26.1, for example SC-P400 (trade name, manufactured by Sakamoto Yakuhin Kogyo Co., Ltd.)),

POP (9) Diglyceryl ether (SP value of 22.7, for example SC-P750 (trade name, manufactured by Sakamoto Yakuhin Kogyo Co., Ltd.)),
POP (20) Diglyceryl ether (SP value of 22.4, for example SC-E1000 (trade name, manufactured by Sakamoto Yakuhin Kogyo Co., Ltd.)),
POP (40) Diglyceryl ether (SP value of 21.0, for example SC-E2000 (trade name, manufactured by Sakamoto Yakuhin Kogyo Co., Ltd.)).

nC₄H₉O(AO)₄—H (AO=EO or PO, the ratio of EO:PO=1:1) (SP value: 20.1)

nC₄H₉O(AO)₁₀—H (AO=E0 or PO, the ratio of EO:PO=1:1) (SP value: 18.8)
HO(A′O)₄₀—H (A′O=EO or PO, the ratio of EO:PO=1:3) (SP value: 18.7)
HO(A″O)₅₅—H (A″O=EO or PO, the ratio of EO:PO=5:6) (SP value: 18.8)
HO(PO)₃—H(SP value: 24.7)
HO(PO)₇—H(SP value: 21.2)

It is also preferable that the water-soluble solvent having an SP value of 27.5 or less in the present invention be also a compound represented by the following general formula (1) or (2), and it is more preferable that the solvent be a compound represented by the following general formula (1).

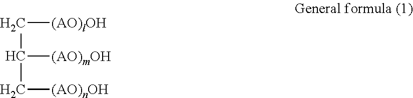

In the general formula (1), l, m, and n each independently represent an integer of 1 or more, and l+m+n=3 to 15. l+m+n is preferably from 3 to 12, and more preferably from 3 to 10.

AO represents an ethyleneoxy group, or a propyleneoxy group, and plural AOs may be the same as each other or may be different from each other. AO is preferably a propyleneoxy group.

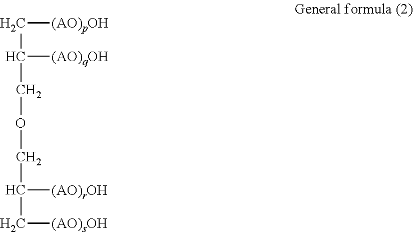

In the general formula (2), p, q, r and s each independently represent an integer of 1 or more, and p+q+r+s=4 to 40. p+q+r+s is preferably from 4 to 20, more preferably from 4 to 16, and particularly preferably from 4 to 12.

AO has the same meaning as the general formula (1), and is preferably a propyleneoxy group.

Specific examples of the compound represented the general formula (1) are shown below, along with the SP value (in parentheses); however, the present invention is not limited to these.

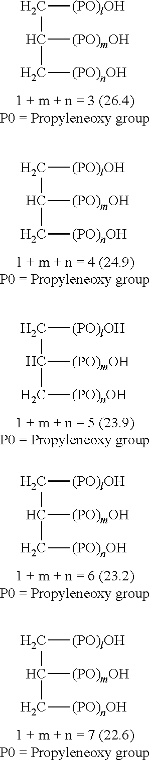

Specific examples of the general formula (2) include the following, but the present invention is not limited to these.

SC-E450 (trade name, manufactured by Sakamoto Yakuhin Kogyo Co., Ltd., SP value of 26.6, p+q+r+s=6, AO=an ethyleneoxy group),

SC-E400 (trade name, manufactured by Sakamoto Yakuhin Kogyo Co., Ltd., SP value of 26.1, p+q+r+s=4, AO=a propyleneoxy group),
SC-E750 (trade name, manufactured by Sakamoto Yakuhin Kogyo Co., Ltd., SP value of 23.7 p+q+r+s=13, AO=an ethyleneoxy group),
SC-P750 (trade name, manufactured by Sakamoto Yakuhin Kogyo Co., Ltd., SP value of 22.7 p+q+r+s=9, AO=a propyleneoxy group),
SC-E1000 (trade name, manufactured by Sakamoto Yakuhin Kogyo Co., Ltd., SP value of 22.4, p+q+r+s=20, AO=an ethyleneoxy group),
SC-E1500 (trade name, manufactured by Sakamoto Yakuhin Kogyo Co., Ltd., SP value of 21.5, p+q+r+s=30, AO=an ethyleneoxy group),
SC-P1000 (trade name, manufactured by Sakamoto Yakuhin Kogyo Co., Ltd., SP value of 21.3, p+q+r+s=14, AO=a propyleneoxy group),
SC-E2000 (trade name, manufactured by Sakamoto Yakuhin Kogyo Co., Ltd., SP value of 21.3, p+q+r+s=40, AO=an ethyleneoxy group),
UNILUBE DGP-700 (trade name, manufactured by NOF CORPORATION, SP value of 22.7, p+q+r+s=9, AO=a propyleneoxy group)
UNILUBE DGP-950 (trade name, manufactured by NOF CORPORATION, SP value of 21.3, p+q+r+s=14, AO=a propyleneoxy group)

In the ink compositions of the present invention, such a water-soluble solvent having an SP value of 27.5 or less may be used singly or in combination of two or more thereof.

The water-soluble solvent (b) preferably contains 10% by mass or more, more preferably 30% by mass or more, and still more preferably 50% by mass or more, of the compound represented by the general formula (1). In addition, the solvent preferably contains 10% by mass or more, more preferably 30% by mass or more, and still more preferably 50% by mass or more, of the compound represented by the general formula (2).

The water-soluble solvent (b) of the present invention may be used in combination with other water-soluble solvents as long as the proportion of the solvent having an SP value of 27.5 or less is not less than 65% by mass. As the water-soluble solvent which is used in combination, a water-soluble organic solvent is preferred.

Examples of a water-soluble organic solvent which can be used in combination include alkane diols (polyhydric alcohols) such as glycerin, 1,2,6-hexanetriol, trimethylolpropane, ethylene glycol, propylene glycol, diethylene glycol, triethylene glycol, tetraethylene glycol, pentaethylene glycol, dipropylene glycol, 2-butene-1,4-diol, 2-ethyl-1,3-hexanediol, 1,2-octanediol, 1,2-hexanediol, 1,2-pentanediol, or 4-methyl-1,2-pentanediol; sugars such as glucose, mannose, fructose, ribose, xylose, arabinose, galactose, aldonic acid, glucitol, maltose, cellobiose, lactose, sucrose, trehalose, or maltotriose; sugar alcohols; hyaluronic acids; and so-called solid wetting agents such as ureas; alkyl alcohols having 1 to 4 carbon atoms such as ethanol, methanol, butanol, propanol or isopropanol;

glycol ethers such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, or dipropylene glycol mono-iso-propyl ether; N-methyl 2-pyrrolidone, 1,3-dimethyl-2-imidazolidinone, formamide, acetamide, dimethylsulfoxide, sorbitol, sorbitan, acetin, diacetin, triacetin, and sulfolane. These may be used singly, or may be used in combination of two or more thereof.

From the viewpoint of prevention of dryness, and wettability of the ink composition, polyhydric alcohols are preferable, and examples thereof include glycerin, ethylene glycol, diethylene glycol, triethylene glycol, propylene glycol, dipropylene glycol, tripropylene glycol, 1,3-butanediol, 2,3-butanediol, 1,4-butanediol, 3-methyl-1,3-butanediol, 1,5-pentanediol, tetraethylene glycol, 1,6-hexanediol, 2-methyl-2,4-pentanediol, polyethylene glycol, 1,2,4-butanetriol, and 1,2,6-hexanetriol. These may be used singly, or may be used in combination of two or more kinds.

From the viewpoint of increasing permeability of the ink composition into the recording material, a polyol compound is preferable, and examples thereof include 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol, and 2-ethyl-1,3-hexanediol. Among these compounds, preferable examples thereof include aliphatic diols such as 2-ethyl-1,3-hexanediol, or 2,2,4-trimethyl-1,3-pentanediol.

The content of the water-soluble solvent (b) in the ink composition is from 30% by mass to 55% by mass, preferably from 33% by mass to 50% by mass, and particularly preferably from 35% by mass to 40% by mass, relative to the total mass of the ink composition.

(c) Surfactant

The ink composition of the present invention contains a surfactant. A compound having a structure in which a hydrophilic moiety and a hydrophobic moiety are combined in a molecule thereof can be used as the surfactant, and any of an anionic surfactant, a cationic surfactant, an amphoteric surfactant, and a nonionic surfactant can be used.

Specific examples of the anionic surfactant include sodium dodecylbenzene sulfonate, sodium lauryl sulfate, sodium alkyl diphenyl ether disulfonate, sodium alkylnaphthalene sulfonate, sodium dialkyl sulfosuccinate, sodium stearate, potassium oleate, sodium dioctyl sulfosuccinate, sodium polyoxyethylene alkyl ether sulfate, sodium polyoxyethylene alkylphenyl ether sulfate, sodium oleate, and sodium t-octylphenoxyethoxy polyethoxyethyl sulfate. One of these surfactants, or two or more thereof can be selected.

Specific examples of the nonionic surfactant include acetylenediol derivatives such as ethylene oxide adducts of acetylenediol, polyoxyethylene lauryl ether, polyoxyethylene octyl phenyl ether, polyoxyethylene oleyl phenyl ether, polyoxyethylene nonyl phenyl ether, oxyethylene-oxypropylene block copolymer, t-octyl phenoxyethyl polyethoxyethanol, and nonylphenoxyethyl polyethoxyethanol. One of these surfactants, or two or more thereof can be selected.

Examples of the cationic surfactant include a tetraalkyl ammonium salt, an alkylamine salt, a benzalkonium salt, an alkylpyridinium salt, and an imidazolium salt, and specific examples include dihydroxyethyl stearylamine, 2-heptadecenyl-hydroxyethyl imidazoline, lauryl dimethyl benzyl ammonium chloride, cetyl pyridinium chloride, and stearamide methylpyridium chloride.

Among these surfactants, in view of stability, the nonionic surfactants are preferable, and acetylenediol derivatives are more preferable.

The amount of the surfactants in the ink composition is not particularly limited, but is preferably 0.1% by mass or more, more preferably from 0.5 to 10% by mass, and still more preferably from 1 to 3% by mass, relative to the total mass of the ink composition.

(d) Water

While the ink composition of the present invention is an aqueous ink containing water, the amount of water is not particularly limited. Among them, the preferable content of water is from 30% by mass or more but less than 70% by mass, more preferably from 50% by mass to 65% by mass, and still more preferably from 53% by mass to 60% by mass, relative to the total mass of the ink composition.

(Other Components)

The ink composition of the present invention may also contain various additives in addition to the components (a) to (d). Examples of other additives include ultraviolet absorbing agents, antifading agents, antifungal agents, pH adjusting agents, rust inhibitors, antioxidants, emulsion stabilizers, preservatives, antifoams, viscosity modifiers, dispersion stabilizers, and chelating agent and the like, and these can be appropriately selected and used, from those which are commonly used.

Examples of the ultraviolet absorbing agents include a benzophenone-based ultraviolet absorbing agent, a benzotriazole-based ultraviolet absorbing agent, a salicylate-based ultraviolet absorbing agent, a cyanoacrylate-based ultraviolet absorbing agent, and a nickel complex salt-based ultraviolet absorbing agent.

Various organic anti-fading agents and metal complex-based anti-fading agents can be used as the anti-fading agents. Examples of the organic anti-fading agents include hydroquinones, alkoxyphenols, dialkoxyphenols, phenols, anilines, amines, indanes, chromanes, alkoxyanilines, and heterocycles. Examples of the metal complexes-based anti-fading agents include a nickel complex and a zinc complex.

Examples of the antifungal agents include sodium dehydroacetate, sodium benzoate, sodium pyridinethione-1-oxide, ethyl p-hydroxybenzoate, 1,2-benzisothiazoline-3-one, sodium sorbate, and sodium pentachlorophenol. These antifungal agents are preferably used in an amount of from 0.02% by mass to 1.00% by mass in the ink composition.

The pH adjusting agents are not particularly limited as long as the pH adjusting agents can set a pH value of the ink composition to a desired value without exerting an adverse influence on the ink composition for recording with which the pH adjusting agents are combined, and can be appropriately selected in accordance with the purpose. Examples thereof include alcohol amines (for example, diethanolamine, triethanolamine, or 2-amino-2-ethyl-1,3-propanediol), alkali metal hydroxides (for example, lithium hydroxide, sodium hydroxide, or potassium hydroxide), ammonium hydroxides (for example, ammonium hydroxide, or quaternary ammonium hydroxide), phosphonium hydroxide, and alkali metal carbonates.

Examples of the antirust agents include acidic sulfite, sodium thiosulfate, ammonium thiodiglycolate, diisopropyl ammonium nitrite, pentaerythritol tetranitrate, and dicyclohexyl ammonium nitrite.

Examples of the antioxidants include phenolic antioxidants (including hindered phenol antioxidants), amine antioxidants, sulfur antioxidants, and phosphorus antioxidants.

Examples of the chelating agents include sodium ethylenediamine tetraacetate, sodium nitrilotriacetate, sodium hydroxyethyl ethylenediamine triacetate, sodium diethylenetriamine pentaacetate, and sodium uramil diacetate.

It is preferable that the ink composition of the present invention do not contain an aqueous dispersion of resin fine particles in addition to the pigment (a). Examples of the aqueous dispersion of such resin fine particles include resin fine particles of polymer latex, and specific examples thereof can include latexes such as acrylic resin, vinyl acetate resins, styrene-butadiene resins, vinyl chloride resins, acrylic-styrene resins, butadiene resins, styrene resins, crosslinked acrylic resins, crosslinked styrene resins, benzoguanamine resins, phenol resins, silicone resins, epoxy resins, urethane-based resins, paraffin-based resins, and fluorine-based resins. The ink composition which does not contain an aqueous dispersion of resin fine particles in addition to the pigment can improve continuous discharge stability, and resettability after printing pause, in a case of using an inkjet head having a high speed drive frequency,

[Colorless Ink Composition]

(e) Coagulation Accelerator

The colorless ink composition of the present invention contains a coagulation accelerator for accelerating coagulation of the ink composition.

As the coagulation accelerator, it is preferable to use acids. Any inorganic acid, or organic acid may be used as the acids. Specific examples of the organic acids include polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furan carboxylic acid, pyridine carboxylic acid, coumaric acid, thiophene carboxylic acid, nicotinic acid, or derivatives of these compounds, or salts thereof. Examples of inorganic acids include magnesium phosphate, and magnesium sulfate. As the coagulation accelerator, it is preferable to use those selected from one, or two or more of these.

The content of the coagulation accelerator in the colorless ink composition is not particularly limited, but from the viewpoint of controlling coagulation rate, and the like, is preferably from 0.1% by mass to 30% by mass, more preferably from 0.5% by mass to 20% by mass, and still more preferably from 1% by mass to 15% by mass, relative to the total mass of the colorless ink composition.

(f) Water-Soluble Solvent

The colorless ink compositions of the present invention contain a water-soluble solvent. The water-soluble solvent is preferably a water-soluble organic solvent.

The water-soluble solvent used in the colorless ink composition contains 90% by mass or more of a water-soluble solvent having an SP value of 27.5 or more. In addition, the definition and the calculation method of the SP value are the same as the SP value of the water-soluble solvent (b) described above.

The water-soluble solvent having an SP value of 27.5 or more used in the colorless ink composition is not particularly limited, but preferably has an SP value of from 28 to 50, and more preferably a value of from 30 to 40, from the viewpoint of accelerating the coagulation at a higher speed and effectively.

Specific examples of the water-soluble solvent having an SP value of 27.5 or more are shown below, along with the SP value (in parentheses); however, the present invention is not limited to these.

Glycerin (33.5)

Propylene glycol (32.6)
Diethylene glycol (30.6)
Ethylene glycol (36.5)

### Trimethylolpropane (33.5)

### Triethanolamine (32.4)

### Diglycerol (31.5)

Glycerol monoacetate (30.5)

### 1,3-Butanediol (30.3)

### 1,2-Butanediol (30.3)

### 2,3-Butanediol (29.9)

### Urea (29.4)

1,5-Pentane diol (29.0)
1,3-Pentane diol (28.6)

### 1,2-Pentanediol (28.6)

5-Methyl-1,3-butanediol (28.4)
Neopentyl glycol (28.4)

### 1,4-Butanediol (27.9)

Triethylene glycol (27.8)
1,6-Hexane diol (27.7)

Among the water-soluble solvents having an SP value of 27.5 or more, it is preferable to use glycerin, propylene glycol, diglycerin, glycerin monoacetate, diethylene glycol, triethylene glycol, and 1,2-alkylene diol.

The water-soluble solvent having an SP value of 27.5 or more may be used singly or in combination of two or more thereof.

In addition, the water-soluble solvent of the colorless ink composition may be used in combination with other water-soluble solvents as long as the proportion of the solvent having an SP value of 27.5 or more is not less than 90% by mass. As the water-soluble solvent which can be used in combination, those mentioned as the examples of the water-soluble solvent (b) of the ink composition described above can be appropriately selected and used.

The content of the water-soluble solvent in the colorless ink composition is not particularly limited, but is preferably from 10% by mass to 70% by mass, more preferably from 20% by mass to 60% by mass, and particularly preferably from 30% by mass to 50% by mass, relative to the total mass of the colorless ink composition.

(Surfactant)

The colorless ink composition of the present invention preferably contains a surfactant. Examples of the surfactant include the same as the surfactant (c) of the ink composition described above. Among these surfactants, in order to increase a coagulation accelerating effect, nonionic surfactants are preferable, and acetylenediol derivatives are more preferable.

The content of the surfactant of the colorless ink composition is not particularly limited, but is preferably from 0.02% by mass or more, more preferably from 0.1% by mass to 3% by mass, and still more preferably from 0.3% by mass to 2% by mass, relative to the total mass of the ink composition.

(Other Components)

In the present invention, a preferred example of the colorless ink composition includes the colorless ink composition which generates a coagulation substance by changing the pH of the ink composition. In this case, the pH of the colorless ink composition is preferably from 1 to 6, more preferably from 2 to 5, and still more preferably from 3 to 5. The pH of the ink composition can be adjusted using the aforementioned acids or the other known pH adjusting agents.

In addition, it is preferable to add a polyvalent metal salt or a polyallylamine to the colorless ink composition.

Examples of the polyvalent metal salt include alkaline earth metals of group 2A of the periodic table (e.g., magnesium and calcium); the transition metals of group 3B of the periodic table (e.g., lanthanum); cations of the group 3A of the periodic table (e.g., aluminum); and lanthanides (e.g., neodymium); polyallylamines, and polyallylamine derivatives. Preferable examples can include calcium and magnesium.

Examples of anions which are preferably adopted as salts of calcium or magnesium can include salts of carboxylic acid (formate, acetate, benzoate, etc.), nitrates, chlorides, and thiocyanates.

The amount of the polyvalent metal salt added to the colorless ink composition is from about 1 to about 10% by mass, more preferably from about 1.5 to about 7% by mass, and still more from about 2 to about 6% by mass.

[Properties of Ink Composition, and Colorless Ink Composition]

It is preferable that the surface tension of the ink composition and the colorless ink composition described above be each independently from 20 mN/m to 40 mN/m, in a case of being used in an inkjet recording method, from the viewpoint of discharge stability. The surface tension is more preferably from 28 mN/m to 38 mN/m, and still more preferably from 32 mN/m to 37 mN/m.

The viscosity of the ink composition and the colorless ink composition described above at 25° C. are each independently preferably from 3 mPa·s to 10 mPa·s, more preferably from 4 mPa·s or more but less than 8.5 mPa·s, and still more preferably from 5 mPa·s or more but less than 7.5 mPa·s

The ink set of the present invention may be applied for general writing instruments, for recorders, and for pen plotters, and the like, and can be suitably used, especially for an inkjet recording method.

[Image Forming Method]

The image forming method of the present invention is a method in which an image formation is performed using an ink set of the present invention described above. It is preferable that the image forming method of the present invention contain the following first step and second step. By applying the colorless ink composition onto a recording medium in the first step, the pigment fixability of the ink composition applied in the second step becomes good.

the First Step: a step of applying the colorless ink composition onto a recording medium; and
the Second Step: a step of applying the ink composition onto the recording medium onto which the colorless ink composition has been applied.

In addition to the above steps, processes which are usually carried out, such as a drying step, or a fixing step may be appropriately added in accordance with the purpose.

(First Step)

As a way to apply a colorless ink composition onto a recording medium, an inkjet ejecting method, and the coating method using a coating applicator are preferable.

The inkjet ejecting method is performed by providing the colorless ink composition with an energy to discharge the colorless ink composition from the inkjet head, and by applying the discharged ink droplets onto a recording medium. Specifically, reference can be made to the methods described in paragraph numbers 0093 to 0105 of JP2003-306623A, and the method can also be preferably used in the present invention.

There is no limit to the inkjet recording method used in the image forming method of the present invention, and the method is used in known methods such as a charge-control method in which a colorless ink composition is discharged by using electrostatic attraction force, a drop-on-demand method (pressure pulse method) in which the oscillating pressure of a piezo element is utilized, an acoustic inkjet method in which the colorless ink composition is discharged using a radiation pressure generated by irradiation to the colorless ink composition with acoustic beams that have been converted from electric signals, and a thermal inkjet method in which the colorless ink composition is heated to form bubbles, and the generated pressure is used. Among them, the piezo method is preferable, in view of the fact that the control of the ink discharge amount is relatively easy and that it is compatible with a wide range of colorless ink compositions.

The coating method using a coating applicator is performed by applying the colorless ink composition onto a recording medium, using the commonly used coating applicator. Examples of the coating applicator include coaters such as a slit coater, a spinner, a whirl coater, a roller coater, a curtain coater, a knife coater, a wire bar coater, or an extruder.

(Second Step)

It is preferable that the application of the ink composition onto a recording medium be performed with an inkjet method. The inkjet ejecting method can be performed in the same way as the first step described above.

[Recording Medium]

The recording medium for the ink composition and the colorless ink composition of the present invention (a image-receiving material) is not particularly limited as long as it has the absorbability, and the retention, of ink to print out, and a normal printing paper including a coated paper such as a coat paper, an art paper, or a photo paper wherein the processing such as coating is carried out to the surface of a base paper; a variety of special papers wherein a functional layer such as an ink-receiving layer is provided on a base paper or a coated paper; and a non-coated paper such as a plain paper, a high-quality paper, or a recycled paper, can be used thereof. Among them, as a recording medium, it is preferable to use a non-coated paper such as a plain paper, a high-quality paper, or recycled paper. The ink composition and the colorless ink composition of the present invention exhibit excellent effects, such as that especially when high-speed printing onto such a non-coated paper is performed, high-definition images are obtained, and further, due to the fast drying, offset does not occur.

### EXAMPLES

Hereinafter, the invention will be described in more detail with reference to examples, although the invention is not limited to the examples. “Parts” and “%” indicate quantities in terms of mass, unless otherwise specified.

### Reference Example

### 1. Preparation of Water-Soluble Resin Dispersant P-1

To isopropanol (187.5 parts) which had been heated to 80° C., under a nitrogen atmosphere, a mixed solution of methyl methacrylate (478 parts)/methacrylic acid (172 parts)/2-ethylhexyl methacrylate (350 parts)/2,2-azobis(2-methyl butyronitrile) (22.05 parts) was added dropwise over 2 hours. After completion of the dropwise-addition, the mixture was kept for a further 4 hours at 80° C., and thereafter was cooled to 25° C. The solvent was removed under reduced pressure to obtain Water-soluble Resin Dispersant P-1 (water-soluble dispersant) having a weight average molecular weight of about 30,000, and an acid value of 154 mgKOH/g.

### 2. Preparation of Pigment Dispersion

Water-soluble Resin Dispersant P-1 (150 parts) was dissolved in water, and thereafter, using an aqueous solution of potassium hydroxide, an aqueous solution of water-soluble resin dispersant was prepared so that the pH thereof after neutralization was 10.1 and the concentration of a water-soluble resin dispersant was 30.6%. 147 parts of the aqueous solution of the water-soluble resin dispersant was mixed with 90 parts of Pigment Blue 15:3 (PHTHALOCYANINE BLUE A220, manufactured by Dainichiseika Color & Chemicals Mfg. Co., Ltd.) and with 362 parts of water, and the mixture was dispersed for 3 hours using a bead mill (0.1 mmΦ zirconia beads) for 3 hours, to obtain Dispersion N1 of uncrosslinked pigment-containing resin particles having a pigment concentration of 15%.

0.35 parts of polyethylene glycol diglycidyl ether was added to 70 parts of Dispersion N1 of uncrosslinked pigment-containing resin particles, and the mixture was allowed to react for six and a half hours at 50° C., followed by cooling to 25° C., to obtain a dispersion of crosslinked pigment-containing resin particles having a pigment concentration of 15% by mass (aqueous pigment dispersion).

### Example

### 1. Preparation of Ink Composition

(1) Ink Composition A1

The aqueous pigment dispersion obtained above and the following components were mixed into the following composition, and the mixture was filtered through a 5 μm membrane filter to prepare Ink Composition A1.

(Composition of Ink Composition A1)

| | |
|---|---|
| Aqueous Pigment Dispersion | 20% by mass |
| Propylene glycol (SP value: 32.6) | 10% by mass |
| SC-E450 (manufactured by Sakamoto Yakuhin | 22% by mass |
| Kogyo Co., Ltd.: ethylene glycol-modified | |
| diglycerol) (SP value: 26.6) | |
| OLFINE E1010 (manufactured by Nissin | 1.5% by mass |
| Chemical Industry Co., Ltd.) | |
| Ion exchange water | Balance |

(2) Ink Compositions A2 to A6

Ink Compositions A2 to A6 were prepared in the same manner as Ink Composition A1 except that the constitutions thereof were changed to those shown in Table 1.

(3) Comparative Ink Compositions B1 to B4

Ink Compositions B1 to B4 were prepared in the same manner as Ink Composition A1 except that the constitutions thereof were changed to those shown in Table 1. In addition, Latex PL-01 used in the Ink Composition B4 was those prepared as follows:

[Preparation of Latex PL-01]

19.8 g of LATEMUL ASK (manufactured by Kao Corporation, carboxylate-based emulsifier), 6 g of 5 mol/L aqueous sodium hydroxide solution, and 0.3 g of 2,2′-azobis(2-amidinopropane) dihydrochloride were added to 120 g of water, and the solution was dissolved homogeneously. The solution was heated to 70° C., and then a monomer mixture of 25.9 g of styrene, 26.3 g of butyl acrylate and 5.1 g of acrylic acid was added thereto over 2 hours under a nitrogen gas flow. Thereafter, the mixture was heated at 70° C. for 2 hours and at 80° C. for 3 hours. After cooling to room temperature, 1 mol/L aqueous sodium hydroxide solution was added thereto under stirring so that the pH reached about 9, to obtain a dispersion liquid of Latex PL-01. The volume average particle diameter of the resulting Latex PL-01 was 115 nm. In addition, the solid content of the dispersion liquid of Latex PL-01 was 33% by mass.

TABLE 1
Ink Composition

| | | A1 | A2 | A3 | A4 | A5 | A6 | B1 | B2 | B3 | B4 |
|---|---|---|---|---|---|---|---|---|---|---|---|
| (a) Pigment | Aqueous pigment | 20 | 20 | 26.7 | 26.7 | 30 | 30 | 20 | 26.7 | 20 | 27 |
| | dispersion | | | | | | | | | | |
| (b) Water-soluble solvent | Glycerin (33.5) | — | — | — | — | — | — | 30 | 18 | — | — |
| Those in parentheses refer | Propylene glycol (32.6) | 10 | — | — | 10 | — | — | 10 | — | — | — |
| to SP values. | Diethylene glycol (30.6) | — | 12 | — | — | — | 8 | — | 5 | — | — |
| | Dipropylene glycol(27.1) | — | — | 8 | — | — | — | — | — | 6 | — |
| | Hexylene glycol (26.8) | — | — | — | — | 7 | — | — | — | — | — |
| | SC-E450 (26.6) | 22 | — | — | 2 | — | — | — | — | — | — |
| | SANNIX GP-250 (26.4) | — | 16 | — | — | 28 | 10 | — | — | — | — |
| | SC-P400 (26.1) | — | — | 25 | — | — | 14 | — | 20 | 20 | 15 |
| | 2-Pyrrolidone (25.9) | — | 8 | — | — | — | — | — | — | — | — |
| | SC-P750 (22.7) | — | — | — | 20 | — | — | — | — | — | — |
| (c) Surfactant | OLFINE E1010 | 1.5 | — | 1 | — | 3 | — | 1.5 | 1.5 | 1 | 1 |
| | SURFYNOL 485 | — | 1.5 | — | 1 | — | 3 | — | — | — | — |
| Others | Latex PL-01 dispersion | — | — | — | — | — | — | — | — | — | 24.2 |
| | liquid | | | | | | | | | | |
| (d) Water | Ion exchange water | Balance | Balance | Balance | Balance | Balance | Balance | Balance | Balance | Balance | Balance |

| | | | | | | | | | | |
|---|---|---|---|---|---|---|---|---|---|---|
| Proportion of a solvent having an SP value of 27.5 or | 68.8 | 66.7 | 100 | 68.8 | 100 | 75 | 0 | 46.5 | 100 | 100 |
| less relative to the total amount of solvent | | | | | | | | | | |
| (% by mass) | | | | | | | | | | |
| The addition amount of (b) water-soluble solvent to | 32 | 36 | 33 | 32 | 35 | 32 | 40 | 43 | 26 | 15 |
| the ink composition (% by mass) | | | | | | | | | | |

*) The numbers in the table refer to % by mass

### 2. Preparation of Colorless Ink Composition

(1) Colorless Ink Composition C1

The mixing was performed with the following constitution to prepare Colorless Ink Composition C1.

(Constitution of Colorless Ink Composition C1)

| | |
|---|---|
| Citric acid | 4% by mass |
| Glycerin (SP value: 33.5) | 12% by mass |
| Propylene glycol (SP value: 32.6) | 6% by mass |
| OLFINE E1010 (manufactured by Nissin | 1% by mass |
| Chemical Industry Co., Ltd.) | |
| Ion exchange water | Balance |

(2) Colorless Ink Compositions C2 to C6

Colorless Ink Compositions C2 to C6 were prepared in the same manner as Colorless Ink Composition C1 except that the constitutions thereof were changed to those shown in Table 2.

(3) Comparative Colorless Ink Compositions D1 and D2

Colorless Ink Compositions D1 and D2 were prepared in the same manner as Colorless Ink Composition C1 except that the constitutions thereof were changed to those shown in Table 2.

TABLE 2
Colorless Ink Composition

| | | C1 | C2 | C3 | C4 | C5 | C6 | D1 | D2 |
|---|---|---|---|---|---|---|---|---|---|
| (e) Coagulation accelerator | Citric acid | 4 | 4 | — | — | — | — | 4 | 4 |
| | Malic acid | — | — | 4 | 4 | — | — | — | — |
| | Phosphoric acid | — | — | — | — | 4 | — | — | — |
| | Magnesium sulfate | — | — | — | — | — | 4 | — | — |
| (f) Water-soluble solvent | Glycerin (33.5) | 12 | 26 | — | 10 | 20 | 18 | — | — |
| Those in parentheses refer to | Propylene glycol (32.6) | 6 | — | 12 | — | — | — | 6 | — |
| SP values. | Diethylene glycol (30.6) | — | 6 | 6 | 20 | — | — | — | — |
| | Dipropylene glycol(27.1) | — | — | — | — | — | 2 | — | — |
| | SC-E450 (26.6) | — | — | 2 | — | — | — | — | — |
| | SANNIX GP-250 (26.4) | — | — | — | 3 | — | — | 12 | — |
| | SC-P750 (22.7) | — | — | — | — | 2 | — | — | 16 |
| pH adjusting agent | Citric acid3Na | — | 12 | — | 12 | 12 | — | — | 12 |
| Surfactant | OLFINE E1010 | 1 | — | 1 | — | 1 | — | 1 | 1 |
| | SURFYNOL 485 | — | 1 | — | 1 | — | 1 | — | — |
| Water | Ion exchange water | Balance | Balance | Balance | Balance | Balance | Balance | Balance | Balance |

| | | | | | | | | |
|---|---|---|---|---|---|---|---|---|
| Proportion of a solvent having an SP value of 27.5 or | 100 | 100 | 90 | 90.9 | 90.9 | 90 | 33.3 | 0 |
| more relative to the total amount of solvent (% by mass) | | | | | | | | |

*) The numbers in the table refer to % by mass.

The details of the solvents and the surfactants as shown in Table 1 and Table 2 are as follows.

SC-E450: Ethylene glycol-modified diglycerin of the above general formula (2) wherein p+q+r+s=6, and AO=an ethyleneoxy group, manufactured by Sakamoto Yakuhin Kogyo Co., Ltd.

SANNIX GP-250: Propylene glycol-modified glycerin of the above general formula (1) wherein l+m+n=3, and AO=a propyleneoxy group, manufactured by Sanyo Chemical Industries.

SC-P400: Propylene glycol-modified diglycerin of the above general formula (2) wherein p+q+r+s=4, and AO=a propyleneoxy group, manufactured by Sakamoto Yakuhin Kogyo Co., Ltd.

SC-P750: Propylene glycol-modified diglycerin of the above general formula (2) wherein p+q+r+s=9, and AO=a propyleneoxy group, manufactured by Sakamoto Yakuhin Kogyo Co., Ltd.

OLFINE E1010: Ethylene oxide (10 moles) adduct of acetylene diol, manufactured by Nissin Chemical Industry Co., Ltd.

SURFYNOL 485: Ethylene oxide adduct of acetylene alcohol, manufactured by Air Products.

### 3. Image Formation

Using the ink set containing the ink composition and the colorless ink composition prepared as described above (Table 3, Examples 1 to 11), the aqueous pigment dispersion (Table 3, Reference Example 1), and the ink set for comparison (Table 3, Comparative Examples 1 to 8), an image was formed on the following recording medium in the order as shown in the following image forming methods 1 and 2.

[Image Forming Method 1]

The colorless ink composition was ejected so as to be 5 g/m² on the recording medium, using DIMATIX MATERIAL PRINTER DMP-3000. After one minute, on the recording medium to which the colorless ink composition had been ejected, using a DIMATIX MATERIAL PRINTER DMP-3000 manufactured by Fuji Film Dimatix Inc. (as a cartridge, using a cartridge formed by modifying a 10 pl discharge cartridge (DMC-11610) so as to allow liquid supply from the outside, and also, by modifying the cartridge to adjust the waveform so as to allow performance of ejecting with a drive frequency of 40 kHz), the ink composition was ejected to form an image.

[Image Forming Method 2]

The colorless ink composition was bar-coated so as to be 5 g/m² on the recording medium. After one minute, on the recording medium to which the colorless ink composition had been applied, using a DIMATIX MATERIAL PRINTER DMP-3000 manufactured by Fuji Film Dimatix Inc. (as a cartridge, using a cartridge formed by modifying a 10 pl discharge cartridge (DMC-11610) so as to allow liquid supply from the outside, and also, by modifying the cartridge to adjust the waveform so as to allow to perform ejecting with a drive frequency of 40 kHz), the ink composition was ejected to form an image.

[Recording Medium Used]

Npi form NEXT-IJ<70>: Manufactured by Nippon Paper Industries Co., Ltd (Basis weight: 81.4−1, +5 g/m²)
Npi form <55>: Manufactured by Nippon Paper Industries Co., Ltd (Basis weight: 64−1, +5 g/m²)

### 4. Evaluation

Each of the images formed in the above were evaluated according to the following items. Results are shown in Table 3.

<Continuous Discharge Stability>

Images were formed under the aforementioned conditions, and the discharge stability was evaluated according to the following criteria. Image unevenness was visually observed.

(1) Discharge rate was 80% or more, after the continuous discharge test for 60 minutes.
(2) Discharge rate was 80% or more, after discharge for a minute, followed by pause for 30 minutes.
(3) Image unevenness was not observed.
—Evaluation Criteria—
   A: In a case of pass in three items
   B: In a case of pass in two items
   C: In a case of fail in two items or more

Incidentally, for the normal use, B or higher rating is required.

<Measurement of Optical Density (OD)>

Under the above conditions, a solid image with a drawing rate of 100% at a resolution of 1200 dpi was formed, and the optical density of the image was measured using an X-Rite 530 from the top side of the paper.
—Evaluation Criteria—
   A: In a case of OD being equal to or more than 0.8
   B: In a case of OD being equal to or more than 0.6 but less than 0.8
   C: In a case of OD being less than 0.6

<Measurement of Back Side Optical Density>

Under the above conditions, a solid image with a drawing rate of 100% at a resolution of 1200 dpi was formed, and the optical density of the image was measured using the X-Rite 530 from the back side of the paper.

—Evaluation Criteria—

A: In a case of OD being equal to or less than 0.15
B: In a case of OD being more than 0.15 but equal to or less than 0.2
C: In a case of OD being less than 0.2

<Character Readability>

Character of “ [symbol] ” of 4 pt (Japanese Kanji) was printed, and then the evaluations on “readable” and “indecipherable” were performed by the visual test of 10 testers.
—Evaluation Criteria—
   A: In a case of being evaluated as “readable” by from nine to ten of the ten people
   B: In a case of being evaluated as “readable” by from six to eight of the ten people
   C: In a case of being evaluated as “indecipherable” by five or more of the ten people

<Drying Characteristics of Prints>

Under the above conditions, a solid image with a drawing rate of 100% at a resolution of 1200 dpi was formed, and after standing for one minute, the same recording medium for evaluation was bonded, and a load of 500 g/cm² was put thereon for 1 minute. Thereafter, the transfer of the coloring material onto the bonded recording medium was visually observed.
—Evaluation Criteria—
   A: In a case where the transfer of the coloring material was not observed at all.
   B: In a case where the transfer of the coloring material was slightly (less than 5% relative to the total area) observed.
   C: In a case where the transfer of the coloring material was observed (equal to or more than 5% relative to the total area).

TABLE 3

| | | | Image | | Optical | Back Side | | Drying |
|---|---|---|---|---|---|---|---|---|
| | Ink | Colorless ink | forming | Continuous | Density | Optical | Character | Characteristic of |
| | composition | composition | method | discharge stability | (OD) | Density | Readability | Prints |
| Example 1 | A1 | C1 | 1 | A | B | A | A | A |
| Example 2 | A2 | C1 | 2 | A | B | A | A | A |
| Example 3 | A3 | C1 | 1 | A | A | A | A | A |
| Example 4 | A4 | C1 | 2 | A | A | A | A | A |
| Example 5 | A5 | C1 | 1 | A | A | A | A | A |
| Example 6 | A6 | C1 | 2 | B | A | A | A | A |
| Example 7 | A2 | C2 | 1 | A | A | A | A | A |
| Example 8 | A2 | C3 | 2 | A | A | A | A | A |
| Example 9 | A2 | C4 | 1 | A | A | A | A | A |
| Example 10 | A3 | C5 | 2 | A | A | A | A | A |
| Example 11 | A3 | C6 | 1 | A | A | A | B | A |
| Reference Example 1 | A1 | — | — | A | A | B | B | A |
| Comparative Example 1 | A1 | D1 | 1 | A | A | B | B | B |
| Comparative Example 2 | A1 | D2 | 2 | A | A | B | B | B |
| Comparative Example 3 | B1 | C2 | 1 | A | B | A | A | C |
| Comparative Example 4 | B2 | C2 | 2 | A | A | B | B | A |
| Comparative Example 5 | B3 | C2 | 1 | C | B | A | A | A |
| Comparative Example 6 | B4 | C2 | 2 | C | A | B | B | C |
| Comparative Example 7 | B1 | D1 | 1 | A | A | B | C | B |
| Comparative Example 8 | B1 | — | — | A | B | C | C | A |

As is clear from Table 3, with the image formation using the ink sets of Examples 1 to 11 containing Ink Compositions A1 to A6 and Colorless Ink Compositions C1 to C6, the results were excellent in all of the evaluation items of continuous discharge stability, optical density, back side optical density, character readability, and drying characteristics of prints,

In contrast, with the image formation using the ink sets of Comparative Examples 1 to 8 containing comparative Ink Compositions B1 to B4 and comparative Colorless Ink Compositions D1 and D2, the results were poor in plural evaluation items, and discharge stability and high-quality images could not be achieved at the same time.

What is claimed is:

1. An ink set comprising:
an ink composition comprising (a) a pigment, (b) a water-soluble solvent, (c) a surfactant, and (d) water; and
a colorless ink composition comprising (e) a coagulation accelerator for accelerating the coagulation of the ink composition, and (f) a water-soluble solvent,
wherein the water-soluble solvent (b) of the ink composition comprises 65% by mass or more of a water-soluble solvent having an SP value of 27.5 or less, and the content of the water-soluble solvent (b) in the ink composition is from 30% by mass to 55% by mass, and
the water-soluble solvent (f) of the colorless ink composition comprises 90% by mass or more of a water-soluble solvent having an SP value of 27.5 or more.

2. The ink set according to claim 1, wherein the water-soluble solvent having an SP value of 27.5 or less in the water-soluble solvent (b) includes a compound represented by the following general formula (1) or (2). 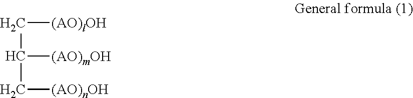
wherein, l, m, and n each independently represent an integer of 1 or more, and l+m+n=3 to 15; AO represents an ethyleneoxy group, or a propyleneoxy group, and plural AOs may be the same as each other or may be different from each other. 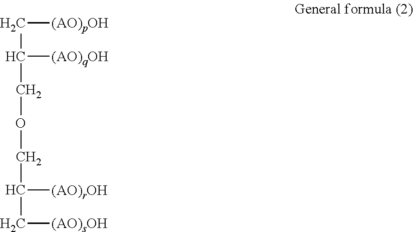
wherein, p, q, r and s each independently represent an integer of 1 or more, and p+q+r+s=4 to 40; AO represents an ethyleneoxy group, or a propyleneoxy group, and plural AOs may be the same as each other or may be different from each other.

3. The ink set according to claim 2, wherein AO in the general formula (1) or (2) is a propyleneoxy group.

4. The ink set according to claim 1, wherein the water-soluble solvent having an SP value of 27.5 or more in the water-soluble solvent (f) includes at least one selected from a group consisting of glycerin, propylene glycol, diglycerin, glycerin monoacetate, diethylene glycol, and triethylene glycol, and 1,2-alkylene diol.

5. The ink set according to claim 1, wherein the pigment (a) is a pigment coated with a polymer, which has been obtained through a step of dispersing the pigment using a water-soluble dispersant, followed by crosslinking with a crosslinking agent.

6. The ink set according to claim 1, wherein the coagulation accelerator (e) in the colorless ink composition is an acid.

7. An image forming method using the ink set according to claim 1.

8. The image forming method according to claim 7, the method comprising:
a first step of applying the colorless ink composition onto a recording medium; and
a second step of applying the ink composition onto the recording medium whereon the colorless ink composition has been applied.

9. The image forming method according to claim 8, wherein the recording medium is a non-coated paper.

10. The image forming method according to claim 8, wherein the application of the ink composition onto the recording medium is performed by an inkjet ejecting method.

11. The image forming method according to claim 8, wherein the application of the colorless ink composition onto the recording medium is performed by an inkjet ejecting method.

12. The image forming method according to claim 8, wherein the application of the colorless ink composition onto the recording medium is performed by a method of coating using a coating applicator.
